(19) United States
(12) Patent Application Publication
(10) Pub. No.: US 2013/0097555 A1
(43) Pub. Date: Apr. 18, 2013

(54) DYNAMIC CONTENT PREVIEW CYCLING MODEL FOR ANSWERS WITH TRANSITIONS

(71) Applicants: Daniel Marantz, Bellevue, WA (US); Manny Tan, New York City, NY (US); Keith A. Regier, Kirkland, WA (US); Alex Bulankou, Redmond, WA (US)

(72) Inventors: Daniel Marantz, Bellevue, WA (US); Manny Tan, New York City, NY (US); Keith A. Regier, Kirkland, WA (US); Alex Bulankou, Redmond, WA (US)

(73) Assignee: Microsoft Corporation, Redmond, WA (US)

(21) Appl. No.: 13/332,399

(22) Filed: Dec. 21, 2011

Related U.S. Application Data
(60) Provisional application No. 61/546,699, filed on Oct. 13, 2011.

(51) Int. Cl. G06F 3/048

(52) U.S. Cl. 715/784

(57) ABSTRACT

Architecture that includes a rendering framework for rendering structured content in structured parts and a set of transitions/interactions which when combined enable a generic item of a list of items to transition item elements to different content views (states) without or without user interaction. The space consumed by the different element content views is pre-computed such that an item in the list is not pushed from view when an element is in a larger version, or a new item added to the list when element content is transitioned back to the smaller content version. All items remain in view independent of whether a single item has an element that is in a different view state. A results model automatically cycles through a preview of the content states of the result entries in the absence of any user interaction, and based on settings configured by the user.

### CROSS-REFERENCE TO RELATED APPLICATIONS

This application claims the benefit of U.S. Provisional Patent Application Ser. No. 61/546,699 entitled “DYNAMIC CONTENT PREVIEW CYCLING MODEL FOR ANSWERS WITH TRANSITIONS” and filed Oct. 20, 2011.

### BACKGROUND

Current implementations and presentations for structured content are static. Traditional web pages and interaction models call for a static presentation and thus, the user needs to dig through links to find the desired result. As the amount of search result information increases on the results page (e.g., in the form of properties on rich content modules “Answers”), the user experience becomes cluttered and accordingly, more difficult to distill the main information about the element. The extra information may be useful; however, there is no secondary space for the content to be presented.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a rendering framework that renders structured content in structured parts and a set of transitions/interactions which when combined enable a generic item of a list of items to transition item elements to different content views (states) without or without user interaction. Additionally, the space consumed by the different element content views is pre-computed such that an item in the list is not pushed from view when an element is in a larger version, or a new item added to the list when element content is transitioned back to the smaller content version. Thus, all items remain in view independent of whether a single item has an element that is in a different view state.

This facilitates a minimally interactive state, where the page starts with a completely functional item. The page items are presented with a consistent, vertical height overall. Thus, a finite amount of space is used on the page for the items. The list of items grows and contracts within the finite amount of space (a fixed container), which is useful for fixed-size scenarios such as mobile devices and tablets, for example. The movement and passive carousel catches the eye of the viewer without being distracting in that the page does not appear to bounce due to the consistent vertical height.

In an application to search engines, queries, and search results, a search result entry (e.g., answer for a natural language query) can have an element that is associated with structured content and configured for a small version of the content and large version of the content. A user interaction (e.g., mouse cursor in virtual contact) with the element causes a transition from the smaller version of content to the larger version of the content and then presentation of the larger version of the content. Similarly, removal of the user interaction (e.g., move mouse cursor away from virtual contact) with the element may cause a reverse transition from the larger version of content to the smaller version of the content and then presentation of the smaller version of the content.

Additionally, the area consumed in association with state changes relative to adjacent or nearby element, is considered. In that a search results page may have multiple search result entries presented, the architecture enables the presentation of (transitioning to) the large content version of an element without displacing another search result entry off the current results page. The capability to surface the different states (sizes) of content versions is performed within a constrained presentation space (e.g., document view of a search results webpage) without causing another result entry from being displaced (pushed) off the current results page. In other words, the optimum space for search result entry presentation on a given page in both the small version and large version is computed such that user interaction to display the larger version does not push another entry off the page, and the transition back to the smaller content of the element does not pull another search result entry back onto the page. This facilitates improved utilization of the presentation space and enables the smaller elements with less information density to give way to the larger elements with greater information density based on user interaction.

In another aspect, the results (e.g., answer) model automatically cycles through a preview of the content states of the result entries in the absence of any user interaction. In one implementation, the cycling parameters can be managed using a control interface that enables the user to configure settings such as transition scale, timer delay, global time, and reset to a previously known set of parameters for each setting. In an alternative implementation, parameter control is not exposed to the user for user for customized setting of the parameters.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system in accordance with the disclosed architecture.

FIG. 3 illustrates a list item in collapsed and expanded view states.

FIG. 4 illustrates an alternative rendition that employs a search result listing as the items.

FIG. 5 illustrates a method in accordance with the disclosed architecture.

FIG. 6 illustrates further aspects of the method of FIG. 5.

FIG. 7 illustrates an alternative method in accordance with the disclosed architecture.

FIG. 8 illustrates further aspects of the method of FIG. 7.

FIG. 9 illustrates an alternative method in accordance with the disclosed architecture.

FIG. 10 illustrates a block diagram of a computing system that executes dynamic content preview and transitioning in accordance with the disclosed architecture.

### DETAILED DESCRIPTION

The disclosed architecture is a rendering framework and set of transitions/interactions which when combined allow for a generic answer to have a small and large version of its elements, allowing improved use of the space and allowing the smaller elements with less information density to give way to the larger elements with greater information density when the user interacts.

The answer model cycles through a preview of the expanded states for each listing. Through expanding inline, and using subtle animations/transitions, the architecture covers a progressive disclosure model for answers with a primary and a secondary view, where the primary scales to the secondary in a consistent, predictable, and seamless manner. This framework is applied to several instances of similar answers to produce a new standard for how results are displayed on the search engine results page (SERP) for a more effective user experience at least with respect the increasing problem of content saturation.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

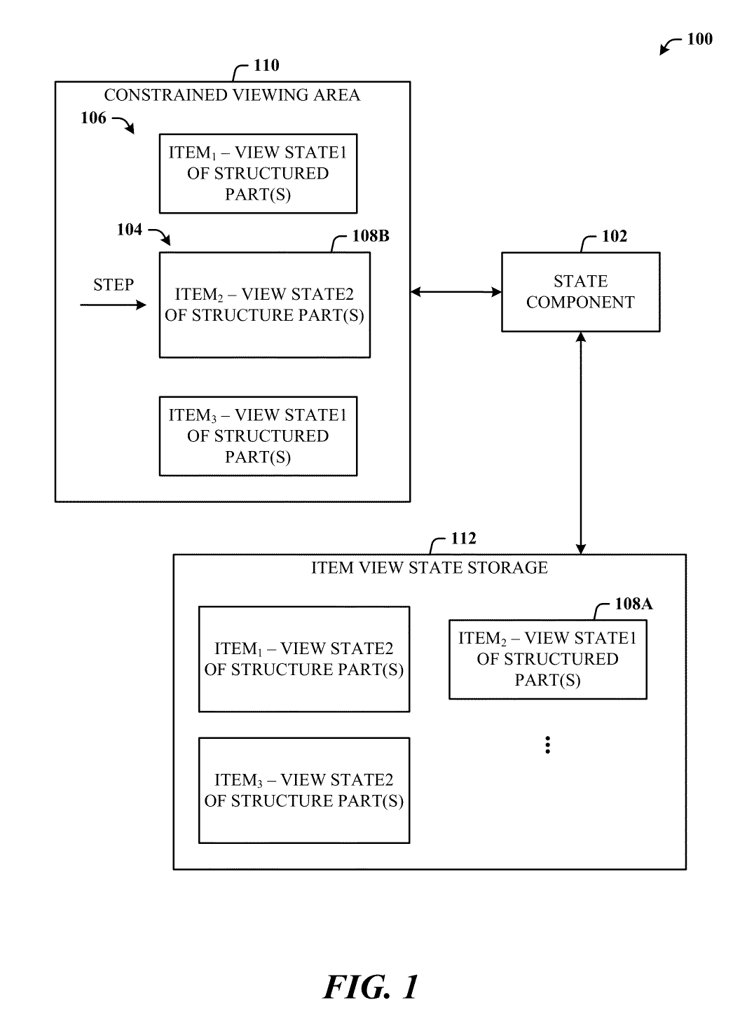

FIG. 1 illustrates a system 100 in accordance with the disclosed architecture. The system 100 includes a state component 102 that visually transitions items (e.g., an item 104) of a list of items 106 between different sized view states (e.g., a first View State1 108A and a second View State2 108B) of structured parts within a constrained viewing area 110 such that the list of items 106 in the constrained viewing area 110 remains constant during the transitions through the list of the items.

The many view states for a single item (e.g., Item₂) and all the items (e.g., Items₁₋₃) can be stored and made accessible via an item view state storage 112 (or cache). For example, when the item 104 is in transition, the state component 102 swaps the first view state 108A for the second view state 108B. As depicted, the second view state 108B for item 104 is currently shown in the list of items 106, and the first view state 108A is then stored in a temporary storage location (e.g., a cache, or the storage 112).

The different view states (e.g., a first View State1 108A and a second View State2 108B) are of correspondingly different sizes and versions of structured parts. The different view states include an expanded view state that shows structured parts that comprise a header, a footer, and a body, such as for a search result. The different views states include a collapsed view state that shows fewer structured parts (e.g., only the header, or only the header and footer of a search result) than the expanded view state (e.g., showing all of a header, a footer, and a body of a search result). The expanded view state shows more item content (as part of the structured parts) than the collapsed view state.

The list of items 106 can be a collection of search results on a search results entry page, and the state component 102 visually transitions (causes to be swapped or changed in a visually perceptible way) each search result between an expanded view state and a collapsed view state while maintaining viewing of all the search results on the page.

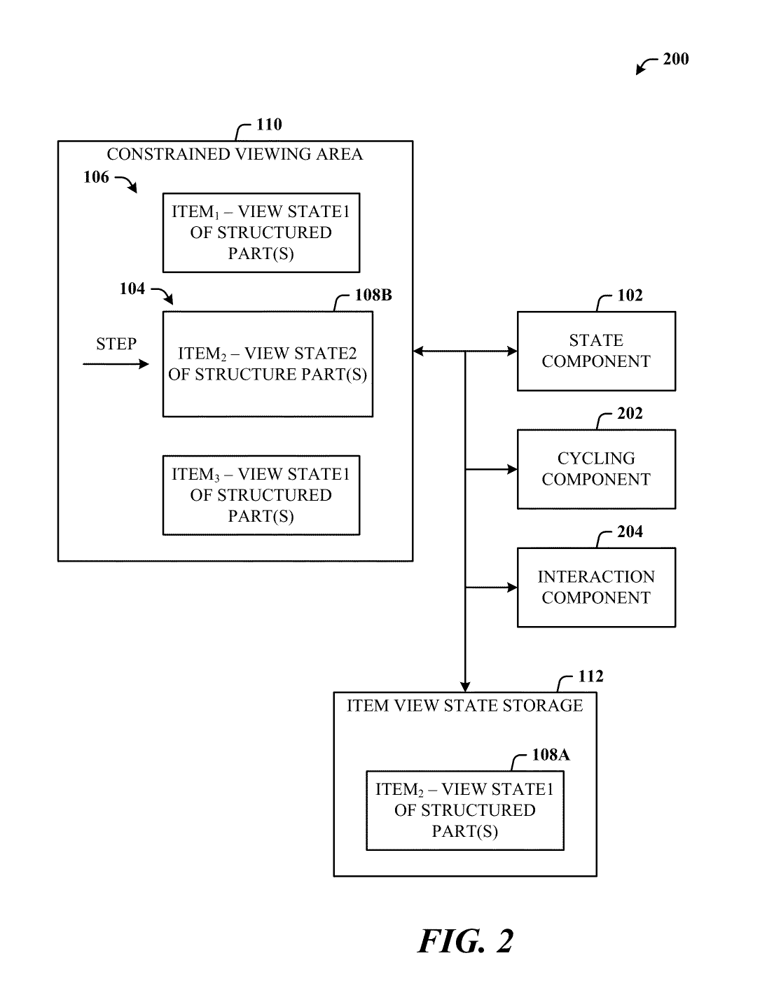

FIG. 2 illustrates an alternative system 200 in accordance with the disclosed architecture. The system 200 can further include the capability of stepping through each item of the list of items 106 and overriding actions or operations enabled by the system 200. Accordingly, a cycling component 202 can provide the capability of automatically stepping (or cycling) through the list of items 106 when the user is not interacting with any single item of the list of items 106. Here, the cycling (or stepping) process is at the second item 104, as indicated by a step pointer (denoted “step” with an arrow), and thus, the transition process occurs to swap the different view states (108A and 108B) into or out of view. In other words, the first view state 108A is swapped out of view and the second view state 108B is swapped into view on the list of items 106. Once the cycling process steps down the list of items 106 to the next item (Item₃), the transition process occurs again to then swap the first state view 108A hack into view for item 104, and to swap out the second state view 108B.

The system 200 can comprise an interaction component 204 that provides the capability to override a predetermined automated action (e.g., cycling or stepping) related to the structured parts in response to a user interaction (e.g., selection of an item, mouse hover over an item, etc) and enables the user interaction. When the user interaction is removed or absent, the interaction component 204 then re-initiates the automated action (or mode) of stepping and transitioning.

In other words, the cycling component 202 enables stepping (e.g., one item at a time) through the list of items 106, and the state component 102 visually transitions an item between the different view states at each step. The cycling component 202 steps through the list of items 106 according to a predetermined time delay (e.g., one or more seconds) at each step. Each step is associated with an individual item in the list. Additionally, stepping (or cycling) can be in a top-down direction on the list of items 106.

The interaction component 204 enables override of a predetermined automated action (e.g., stepping or cycling) related to the structured parts in response to a user interaction. The interaction component 204 processes the user interaction to enable pause of stepping through the list of items at a specific item and the visual transitioning between the different view states associated with the item.

The state component 102 can comprise either or both of the cycling component 202 or/and the interaction component 204 such that all related functionality is communicated via the state component 102.

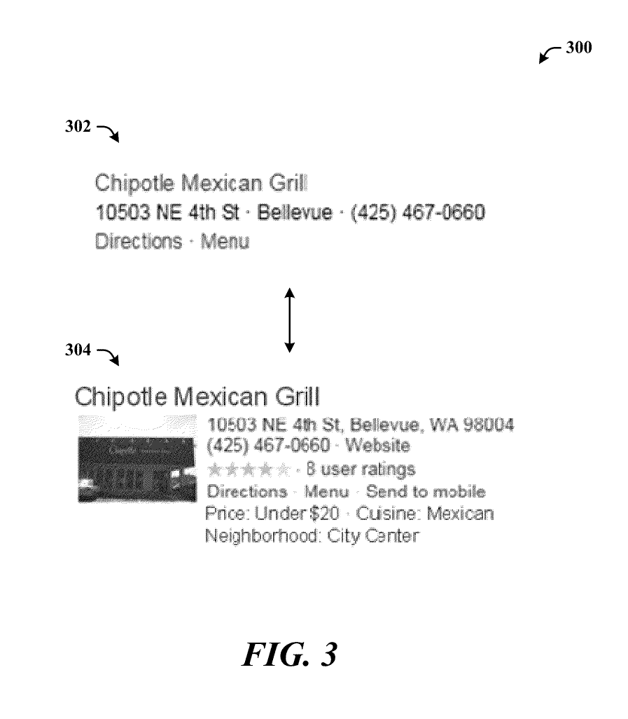

FIG. 3 illustrates a list item 300 (e.g., search result entry) in collapsed and expanded view states. Here, a first list item 302 (e.g., a search result entry) is in a first view state (also be referred to as a collapsed view state) while a second list item 304 is in a second view state (also referred to as an expanded view state). The items (302 and 304) show different amounts of structured state (content). For example, where a search result entry is defined as including a caption (e.g., title, snippet, and attribute (URL)), the second list item 304 shows a full snippet (rather than partial snippet or no snippet) and also includes an image (another type of structured part).

As a framework for a question/answer model (similar to a query/search result model), the answer visual structure has a listing of items, where each item has expanded and collapsed states, and each expanded state is represented as having a header, body, and footer component. When collapsed, the header (and in some cases, also the footer) are shown. When expanded, all structured parts (header, body, and footer) are shown. It is the body of the item that contains most of the content and hence, the more complex elements such as an image, etc.

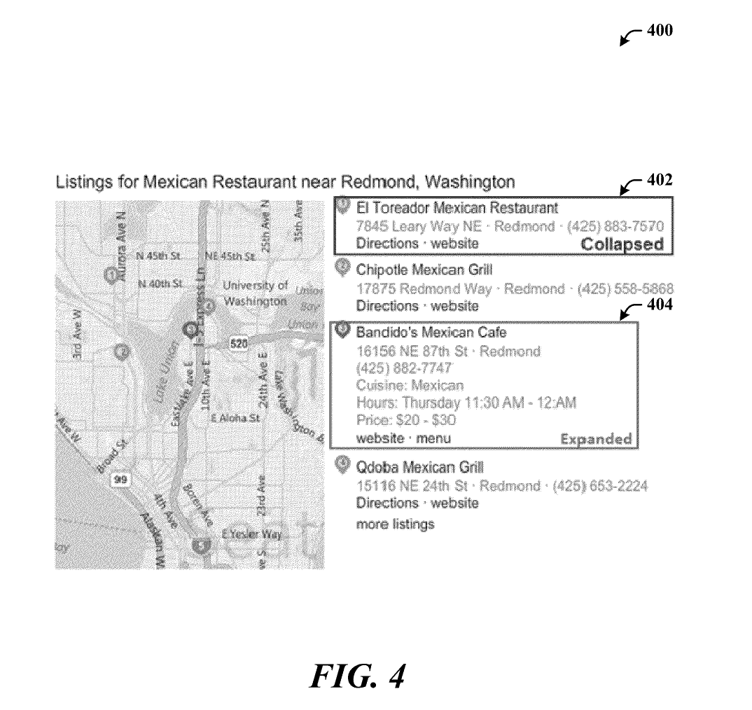

FIG. 4 illustrates an alternative rendition 400 that employs a search result listing as the items. The search result listing shows a top result entry 402 in a collapsed view state and a third result entry 404 in an expanded view state. In operation, the cycling component 202 steps down the search result entries, and once reaching the bottom of the list, loops back to the top to begin again at the top of the list.

The cycling model (as executed by the cycling component 202) coordinates with the state component 102 to transition between different view states. The system (100 or 200) can initially begin by starting with the first list item expanded by default; and all other list items are in a collapsed state. A user configurable timer controls the stepping rate (or cycle rate) through the list such that view state transitions occur at the stepping rate (e.g., expands list item #2 as it collapses list item #1, then expands list item #3 as it collapses list item #2, and so on, finally looping from the bottom of the list back to the top).

The visual transitions of the list items and steady presentation (relatively stable vertical movement of the list overall) of the list items reinforce the slowly moving content, and the concept that there are “expanded” deeper details behind the smaller (collapsed) listings in the set (collection).

Interactions between items in the list include, but are not limited to, mouse-over on any defined section of the item, stops the timer(s), expands the list item subjected to the mouse-over, and collapses the previously expanded list item in absence of the mouse-over. When the user interaction is removed, or absent (e.g., mouse-over leaves the answer area), the timer (stepping time or time delay) restarts with the next list item, which is then expanded.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

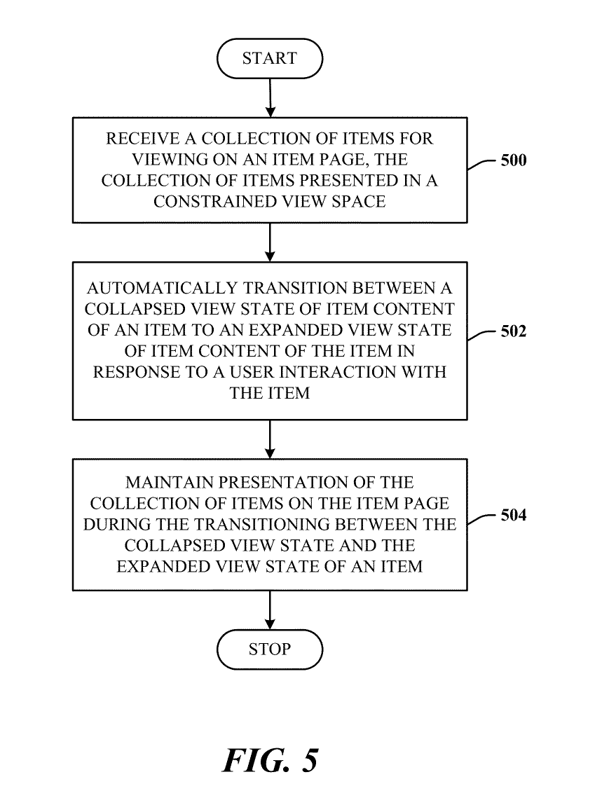

FIG. 5 illustrates a method in accordance with the disclosed architecture. At 500, a collection of items is received for viewing on an item page. The collection of items is presented in a constrained view space. At 502, automatic transitioning is performed between a collapsed view state of item content of an item to an expanded view state of item content of the item in response to a user interaction with the item. At 504, presentation of the collection of items is maintained on the item page during the transitioning between the collapsed view state and the expanded view state of an item.

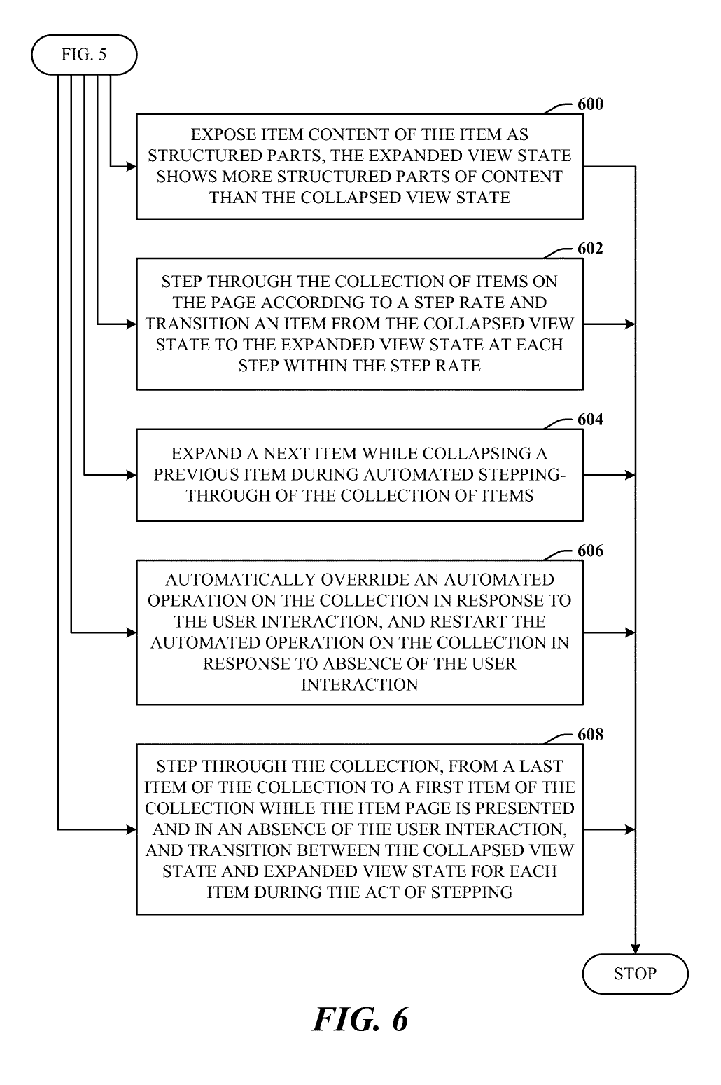

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, the item content of the item is exposed as structured parts, the expanded view state shows more structured parts of content than the collapsed view state. At 602, the collection of items on the page is stepped through according to a step rate and an item is transitioned from the collapsed view state to the expanded view state at each step within the step rate.

At 604, a next item is expanded while collapsing a previous item during automated stepping-through of the collection of items. At 606, an automated operation on the collection is automatically overridden in response to the user interaction, and the automated operation on the collection is restarted in response to absence of the user interaction. At 608, step through the collection, from a last item of the collection to a first item of the collection while the item page is presented and in an absence of the user interaction, and transition between the collapsed view state and expanded view state for each item during the act of stepping.

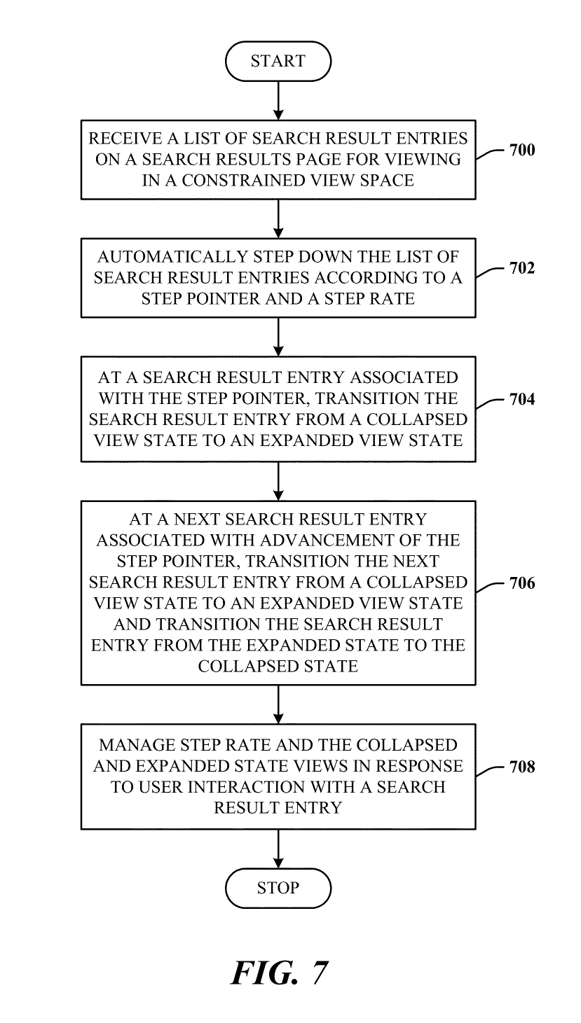

FIG. 7 illustrates an alternative method in accordance with the disclosed architecture. At 700, a list of search result entries on a search results page is received for viewing in a constrained view space. At 702, automatically step down the list of search result entries according to a step pointer and a step rate. At 704, at a search result entry associated with the step pointer, the search result entry is transitioned from a collapsed view state to an expanded view state. At 706, at a next search result entry associated with advancement of the step pointer, the next search result entry is transitioned from a collapsed view state to an expanded view state and transitioning the search result entry from the expanded state to the collapsed state. At 708, the step rate and the collapsed and expanded state views are managed in response to user interaction with a search result entry.

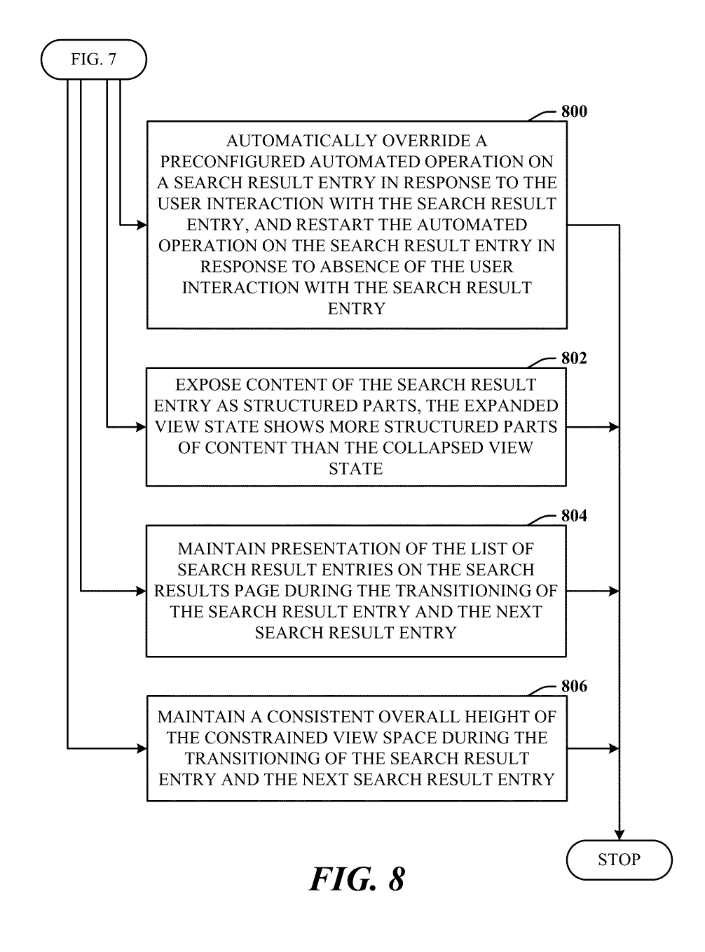

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, a preconfigured automated operation on a search result entry is automatically overridden in response to the user interaction with the search result entry, and the automated operation is restarted on the search result entry in response to absence of the user interaction with the search result entry. At 802, content of the search result entry is exposed as structured parts, the expanded view state shows more structured parts of content than the collapsed view state. In other words, the content is divided into the structured parts for manipulation in accordance with collapsed and expanded view state transitioning.

At 804, presentation of the list of search result entries on the search results page is maintained during the transitioning of the search result entry and the next search result entry. At 806, a consistent overall height of the constrained view space is maintained during the transitioning of the search result entry and the next search result entry.

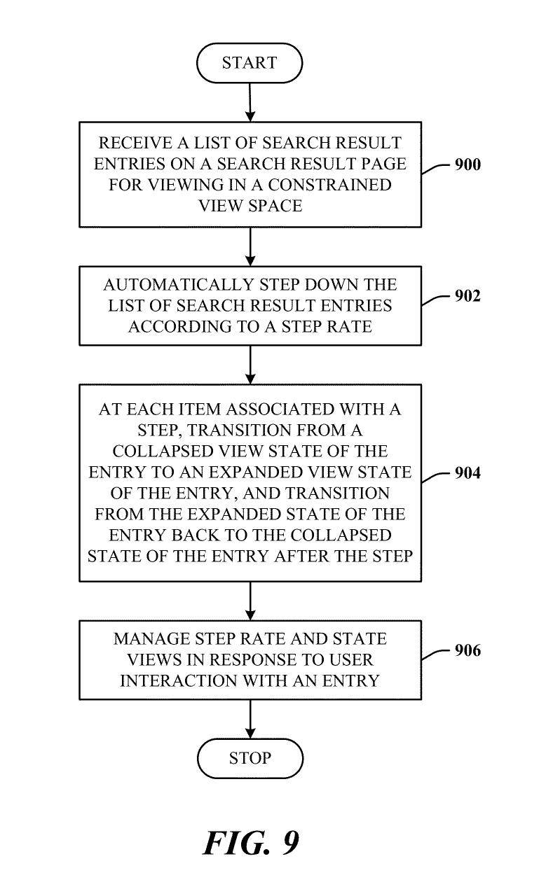

FIG. 9 illustrates an alternative method in accordance with the disclosed architecture. At 900, a list of search result entries on a search result page is received for viewing in a constrained view space. At 902, automatically step down the list of search result entries according to a step rate. At 904, at each item associated with a step, transition from a collapsed view state of the entry to an expanded view state of the entry, and transition from the expanded state of the entry back to the collapsed state of the entry after the step. At 906, the step rate and state views are managed (e.g., stepping halted by suspending step timer, toggle between state views, etc.) in response to user interaction with an entry.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

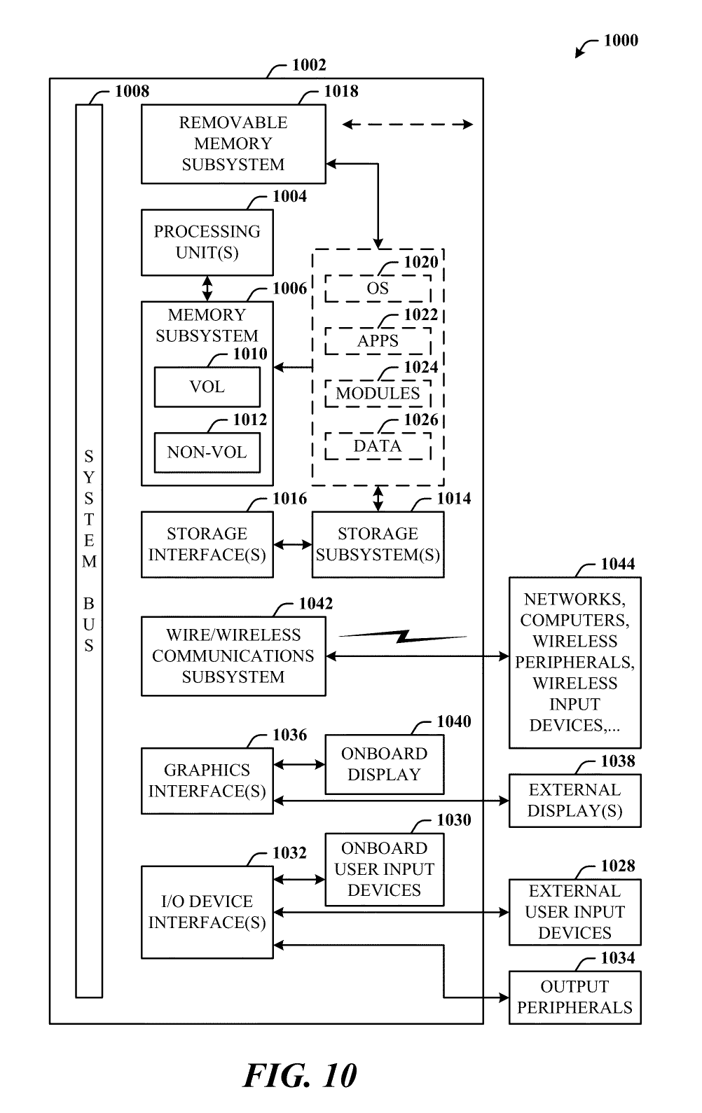

Referring now to FIG. 10, there is illustrated a block diagram of a computing system 1000 that executes dynamic content preview and transitioning in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystem(s) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include entities and components of the system 100 of FIG. 1, entities and components of the system 200 of FIG. 2, the views states of FIG. 3, the alternative rendition of FIG. 4, and the methods represented by the flowcharts of FIGS. 5-9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe ever conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a state component that visually transitions an item of a list of items between different view states of structured parts within a constrained viewing area such that the list of items in the constrained viewing area remains constant during the transitions; and
a processor that executes computer-executable instructions associated with the component.

2. The system of claim 1, wherein the different view states are of correspondingly different sizes and versions of structured parts.

3. The system of claim 1, wherein the different view states include an expanded view state that shows structured parts that comprise a header, a footer, and a body.

4. The system of claim 3, wherein the different views states include a collapsed view state that shows fewer structured parts than the expanded view state, the expanded view state shows more item content than the collapsed view state.

5. The system of claim 1, wherein the list of items is a collection of search results on a search results entry page, and the state component visually transitions each search result between an expanded view state and a collapsed view state while maintaining viewing of all the search results on the page.

6. The system of claim 1, further comprising a cycling component that enables stepping through the list of items, and the state component visually transitions an item between the different view states at each step.

7. The system of claim 6, wherein the cycling component steps through the list of items according to a predetermined time delay at each step.

8. The system of claim 1, further comprising an interaction component that enables override of a predetermined automated action related to the structured parts in response to a user interaction.

9. The system of claim 8, wherein the interaction component processes the user interaction to enable pause of stepping through the list of items at a specific item and the visual transitioning between the different view states associated with the item.

10. A method, comprising acts of:
receiving a collection of items for viewing on an item page, the collection of items presented in a constrained view space;
automatically transitioning between a collapsed view state of item content of an item to an expanded view state of item content of the item in response to a user interaction with the item;
maintaining presentation of the collection of items on the item page during the transitioning between the collapsed view state and the expanded view state of an item; and
utilizing a processor that executes instructions stored in memory to perform at least one of the acts of receiving, transitioning, or maintaining.

11. The method of claim 10, further comprising exposing the item content of the item as structured parts, the expanded view state shows more structured parts of content than the collapsed view state.

12. The method of claim 10, further comprising stepping through the collection of items on the page according to a step rate and transitioning an item from the collapsed view state to the expanded view state at each step within the step rate.

13. The method of claim 10, further comprising expanding a next item while collapsing a previous item during automated stepping-through of the collection of items.

14. The method of claim 10, further comprising automatically overriding an automated operation on the collection in response to the user interaction, and restarting the automated operation on the collection in response to absence of the user interaction.

15. The method of claim 10, further comprising stepping through the collection, from a last item of the collection to a first item of the collection while the item page is presented and in an absence of the user interaction, and transitioning between the collapsed view state and expanded view state for each item during the act of stepping.

16. A method, comprising acts of:
receiving a list of search result entries on a search results page for viewing in a constrained view space;
automatically stepping down the list of search result entries according to a step pointer and a step rate;
at a search result entry associated with the step pointer, transitioning the search result entry from a collapsed view state to an expanded view state;
at a next search result entry associated with advancement of the step pointer, transitioning the next search result entry from a collapsed view state to an expanded view state and transitioning the search result entry from the expanded state to the collapsed state;
managing the step rate and the collapsed and expanded state views in response to user interaction with a search result entry; and
utilizing a processor that executes instructions stored in memory to perform at least one of the acts of receiving, stepping, transitioning, or managing.

17. The method of claim 16, further comprising automatically overriding a preconfigured automated operation on a search result entry in response to the user interaction with the search result entry, and restarting the automated operation on the search result entry in response to absence of the user interaction with the search result entry.

18. The method of claim 16, further comprising exposing content of the search result entry as structured parts, the expanded view state shows more structured parts of content than the collapsed view state.

19. The method of claim 16, further comprising maintaining presentation of the list of search result entries on the search results page during the transitioning of the search result entry and the next search result entry.

20. The method of claim 16, further comprising maintaining a consistent overall height of the constrained view space during the transitioning of the search result entry and the next search result entry.
